(19) United States
(12) Patent Application Publication
(10) Pub. No.: US 2014/0075763 A1
(43) Pub. Date: Mar. 20, 2014

(54) EATING OR ORAL CARE UTENSIL

(71) Applicants: STEPHANIE KARNS, NAMPA, ID (US); RODNEY A. SQUIBB, NAMPA, ID (US)

(72) Inventors: STEPHANIE KARNS, NAMPA, ID (US); RODNEY A. SQUIBB, NAMPA, ID (US)

(21) Appl. No.: 13/941,319

(22) Filed: Jul. 12, 2013

Related U.S. Application Data
(60) Provisional application No. 61/701,705, filed on Sep. 16, 2012.

(51) Int. Cl. B25G 1/10; A46B 5/02

(52) U.S. Cl. CPC B25G 1/102; A46B 5/02
USPC 30/322; 15/167.1

(57) ABSTRACT

An eating/oral care device has a concave or curved head and spaced-apart, broad protrusions in the interior space of the head, for children or challenged adults having difficulty with a conventional fork or spoon. The protrusions are fewer and more spaced-apart, and have a larger diameter to length to ratio, than toothbrush or other conventional bristles. The protrusions have a lower diameter to length ratio than nubs or bumps. The head may be an elongated, curved arm, having low or no sidewalls and an upwardly-extending rear end serving as a food and safety stop. Multiple longitudinal rows of protrusions may extend along the curved upper surface of the arm. The preferred utensil handle is spherical, which allows the user to grasp the device comfortably and naturally in various orientations, and to handle the utensil in a way that improves food-pick-up and aiming at the mouth.

This application claims benefit of U.S. Provisional Application Ser. No. 61/701,705, filed Sep. 16, 2012, the entire disclosure of which is incorporated herein by this reference.

### BACKGROUND

1. Field of the Invention

The invention relates to eating and/or oral care utensils. More specifically, the invention relates to a utensil that comprises broad protrusions in a concave and/or curved head, for capturing and lifting food to a user's mouth and/or for massaging or cleaning the user's mouth. A ball-shaped handle may be provided on the utensil, for comfortable and effective use by a child or other person to help develop skills and/or compensate for reduced agility or strength.

2. Related Art

Several eating or oral care utensils have been proposed for increasing ease-of-use and/or safety. Eating utensils that have been designed that have elongated handles connected to the spoon or fork head so that the head extends transversely to the handle longitudinal axis. Brody, in U.S. Pat. No. 4,523,781, issued Jun. 18, 1985, discloses a gripping aid for the manually disabled that is an elongated “barrel-shaped” handle that slidably receives conventional fork, knife or toothbrush heads, wherein the heads extend transversely to the length of the “barrel”. Kohn, in U.S. Pat. No. 4,386,448, issued Jun. 7, 1983, discloses a ball-shaped device into which a conventional toothbrush or conventional fork or spoon may be inserted. Also, NUK™/Gerber™ offer training tooth brushes with “nubs” on a conventional flat toothbrush head or surrounding a prolate spheroid (or football-shaped) head.

Still, there is a need for an improved eating and/or oral care device that is comfortable and effective for a child or an agility- or strength-challenged person to use. There is a need for such a device that is especially effective for the various tasks involved in eating. For example, such eating tasks may include capturing, lifting, and then depositing the food into the user's mouth, some of all which can be challenging for a child or an agility- or strength-challenged person to perform and learn. Alternatively, or in addition, there is a need for a device that is especially effective for oral care, for example, gum massage or tooth cleaning with a head preferably having both generally flexible portions and relatively-inflexible, but still non-gouging and non-abrasive, portions. The invented device meets some or all of these needs, in the form of an aesthetically-pleasing, safe, and fun-to-use utensil.

### SUMMARY

The invented device comprises an eating and/or oral care device that is especially-adapted for effective and comfortable eating or oral care. In certain embodiments, a combination of a head having a concave and/or curved main body, and spaced-apart, broad protrusions inside the main body, specially-adapting the device for capturing and handling of food. Said combination may allow children and agility- or strength-challenged people to capture and handle food more effectively than they could with a conventional fork or spoon.

Traditional baby/toddler foods, and even many adult foods, often comprise viscous liquids such as gels, purees, sauces, and pasta, soups, and other dishes that comprise solid food bits dispersed therein. Such foods will slide off of a conventional spoon or fork and/or be too chunky or thick to be eaten by a straw or by dipping a conventional utensil in the food. The preferred embodiments of the eating and/or oral care device comprise a significantly-concave or significantly-curved head, with broad, spaced-apart, flexible or somewhat-flexible protrusions inside the concave or curved space of the head, resulting in a utensil head that captures both viscous liquids and solid food bits and retains them during lifting and insertion into the mouth. Said capture and retention is preferably effective even the head is tilted or turned, for example, when dipping/scooping up the food or being lifting to the user's mouth.

In certain embodiments, the protrusions are fewer and more spaced apart, and have a larger diameter to length to ratio, than toothbrush bristles or other conventional bristles. A three-dimensional space in/of the head of the device may be bounded, in certain embodiments, generally by the concave and/or curved wall of the main body of the head and the top ends of the protrusions, wherein the space is generally/substantially open at the top because the protrusions are significantly-spaced-apart. In certain embodiments wherein the main body of the head does not have high sidewalls, the three-dimensional space in/of the head of the device may be bounded generally by the curved wall of the main body of the head, the top ends of the protrusions, and the outer sides of the outermost protrusions, the space being generally/substantially open at the top because the protrusions are significantly-spaced-apart. These and/or other embodiments of said three-dimensional space provide a food capture space/zone.

The protrusions may be considered upending “pillars” that serve as baffles inside the food-capture space of the head, wherein the sidewalls (side surface(s)) of the protrusions act as containment surfaces adjacent to relatively large open spaces in between the protrusions. Thus, the substantial open volume inside the concave/curved main body of the head, divided up into portions bounded/divided by the upending protrusions, receives a substantial amount of food that is prevented, or at least limited in most orientations of the utensil, from sliding/falling off the utensil.

In addition to the specially-adapted utensil head, certain embodiments of the device comprise a handle that is spherical, which allows the user to more effectively use the device, compared to a conventional utensil. Said more effective use may increase the user's comfort, nutrition, oral health, and/or, in the case of a child or a physically-challenged adult, improve learning and/or good habit-formation. In certain embodiments, the spherical handle may be generally of the same diameter or more preferably slightly larger than the curvature/diameter of the bowl-shaped or curved head along its longitudinal axis. Due to its symmetry around the sphere's center, a user may grasp the device comfortably and naturally in several orientations, to improve food-pick-up and aiming at the mouth.

In certain embodiments, the handle is exactly spherical, and in certain embodiments the handle is generally spherical, for example, slightly prolate or varying slightly in diameter due to indentations, ridges, bumps or other surface texture. It is preferred that the handle not be significantly prolate and not significantly elongated in any direction.

In certain embodiments, a mouth-stop may be provided on the device, for preventing over-insertion of the utensil into the mouth, and for helping with food pick-up and removal from the concave/curved head. In the preferred embodiment, the mouth-stop is a rear (proximal) portion rear wall of the concave/curved head raised above the adjacent (front and side) portions head. This relatively tall, curved surface may help as a back-stop during food-scooping, a limit beyond which the lips do not go (to stop over-insertion), and a control surface against which the user's teeth or upper lip may abut, slide, and/or seal to help the mouth remove food from the head. Therefore, the mouth-stop may serve as a safety feature, but also a teaching feature to help the user increase coordination and effective eating habits.

These and/or other objectives and preferred or optional features of the invented device will be apparent from the drawings and the detailed description. The drawings portray a preferred embodiment, and are not to be construed to limit the invention to only the specific details and means shown therein.

### BRIEF DESCRIPTION OF THE DRAWINGS

FIG. 1 is a rear perspective view of one embodiment of the invented eating and/or oral care device.

FIG. 2 is a right side view of the device of FIG. 1, wherein the left side view of this embodiment would be a minor image of this view.

FIG. 3 is a top view of the device of FIG. 1.

FIG. 4 is a bottom view of the device of FIG. 1.

FIG. 5 is a front (distal, away from the hand) view of the device of FIG. 1.

FIG. 6 is a rear (proximal, near the hand) view of the device of FIG. 1.

FIG. 7 is an enlarged, partial view of the utensil of FIG. 1, showing a top view of the head and also side views of selected protrusions to illustrate example thickness/diameter to length ratios.

FIG. 8A is a side view illustrating one way of using the utensil of FIG. 1.

FIG. 8B is a side view illustrating use of the utensil of FIG. 1, with a different hand orientation on the handle of the utensil.

FIG. 9A is a top view of the utensil of FIG. 1, showing one example of hand placement around the handle.

FIG. 9B is a top view of the utensil of FIG. 1, showing an alternative example of hand placement around the handle.

FIG. 10 is a front-left view of an alternative embodiment of the invented eating and/or oral care device.

FIG. 11 is a left side view of the device of FIG. 10.

FIG. 12 is a top view of the device of FIG. 10.

FIG. 13 is a bottom view of the device of FIG. 10.

FIG. 14 is a front view of the device of FIG. 10.

FIG. 15 is a rear view of the device of FIG. 10.

FIG. 16 is a top, detail view of the head-end of the device of FIG. 10.

FIG. 16A is a longitudinal cross-sectional view of the head of the embodiment of FIG. 10, viewed along the line 16A-16A in FIG. 16.

FIG. 16B is a longitudinal cross-sectional view of the head of the embodiment of FIG. 10, viewed along the line 16B-16B in FIG. 16.

FIG. 16C is a transverse cross-sectional view of the head of the embodiment of FIG. 10, viewed along the line 16C-16C in FIG. 16.

FIG. 16D is a transverse cross-sectional view of the head of the embodiment of FIG. 10, viewed along the line 16D-16D in FIG. 16.

FIG. 16E is a transverse cross-sectional view of the head of the embodiment of FIG. 10, viewed along the line 16E-16E in FIG. 16.

FIGS. 17A and B are enlarged top-left perspective and left side views, respectively, of the head of the embodiment of FIG. 10, wherein dashed lines schematically surround, and generally indicate, the three-dimensional food-capture space bounded by the curved-arm head and its upending protrusions.

### DESCRIPTION OF PREFERRED EMBODIMENTS

Referring to the Figures, there are shown several, but not the only, embodiments of the disclosed device for use in eating, oral care and/or other personal tasks. The device is especially well-adapted for use by a child or other person who is learning the skills of eating or caring for their teeth, or who has hand, arm, or agility disabilities. For a child, a conventional eating utensil can be very clumsy and difficult to use. Effective use of a conventional spoon or fork tends to require certain sets of actions, for example as described below.

One set of actions may be described as clenching the utensil around the elongated handle that is parallel to the length of the spoon head or fork tines, keeping the utensil generally transverse to the forearm but pivoting the arm and hand to raise the elbow and lower the utensil head to scoop or “shovel” the head of the utensil into the food, and then, with the elbow still raised (and the arm generally horizontal), bending the elbow to bring the hand and utensil head to the mouth. This first set of actions allows a more natural relationship of the hand to the forearm (without pivoting the hand or bending the wrist greatly), but a less natural, raised relationship of the arm and elbow to the torso.

A second set of actions may be described as clenching the utensil around the elongated handle as in the first set of actions, above, but keeping the elbow relatively close to the torso but pivoting the hand significantly relative to the forearm to scoop the head of the utensil into the food, and then, with the elbow still lowered (and the arm generally vertical), bending the elbow and further bending the hand/wrist relative to the forearm to bring the hand and utensil to the mouth.

A third set of actions may be described as an “adult American-style” grasp of the handle. This approach features the utensil handle resting on, and generally parallel to, the index and/or middle finger (bent at their proximal interphalangeal joints, IPJ) and the thumb generally transverse to the handle and pressing the handle against said index and/or middle fingers. This way, the index and middle fingers and thumb substantially control the handle and can pivot/bend (especially at said IPJ) to move the utensil relative to the palm and the forearm. This grasp is somewhat similar to a classic “pencil-grip” and/or a “chop-sticks-grip”, and is comfortable once learned, but it requires significant finger and thumb dexterity and control.

Anyone analyzing the steps involved in eating with a conventional, elongated-handle utensil will understand that these, or other actions for such eating, may be difficult for a child or an agility- or strength-challenged person, especially when the head of the utensil needs to be kept level to retain the food/liquid. Most grasps and actions required for a conventional, elongated-handle utensil seem at first “contorted”, or at best “unnatural”, and result in many spills and smears of food and even frustration. Similar actions are needed for brushing teeth with a conventional toothbrush, which again has an elongated handle parallel to the elongated head of the brush. Even though food is not being balanced on the toothbrush, brushing teeth requires the user to insert the brush head into his/her mouth and then to manipulate the brush head inside the mouth accurately enough to clean the teeth, while the arm and/or hand and wrist are in what may be described as unnatural positions.

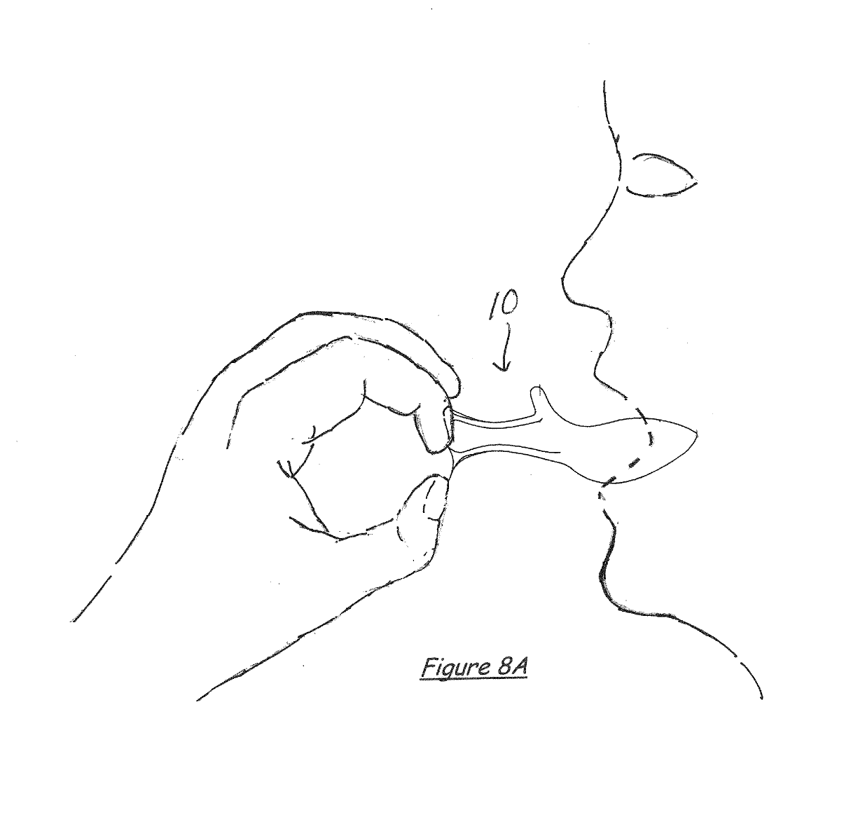

Certain embodiments of the invented utensil makes it much easier to use natural motions in eating and/or brushing. Compared to using conventional utensils, it is easier for many people to use the invented utensil. For example, the user may leave the arm more relaxed at the user's side or with the elbow only slightly raised, and then flex the elbow to lift the utensil generally vertically toward the mouth, and then further “curl” the hand in a plane parallel to the plane of the arm to reach the mouth. See FIGS. 8A and B, for example. Further, it is easier for the user to grasp the spherical handle in various ways to place the head in an orientation relative to the user's hand that is conducive to comfort and successful eating. See all of FIGS. 8A and B and 9A and B, for example.

Further, almost no matter how the user is holding or using certain embodiments of the invented utensil, the utensil captures and holds food more effectively than conventional utensils throughout the actions required to get the food to the mouth. Even when some tipping of the utensil is needed, the food will tend to remain on the utensil head until pulled or sucked off by the user's mouth and lips.

The more natural motions and improved food retention, of certain embodiments of the invented utensil head, will increase success and comfort, lessen mess and spills, and generally reinforce effective skills and a positive experience. Once a child's coordination catches up with conventional utensils, a parent or daycare provider will find it easier to transition the child to the conventional utensils. Also, certain embodiments of the invented utensil allow safe and effective rubbing of the utensil on the gums and teeth, which may have beneficial oral care consequences.

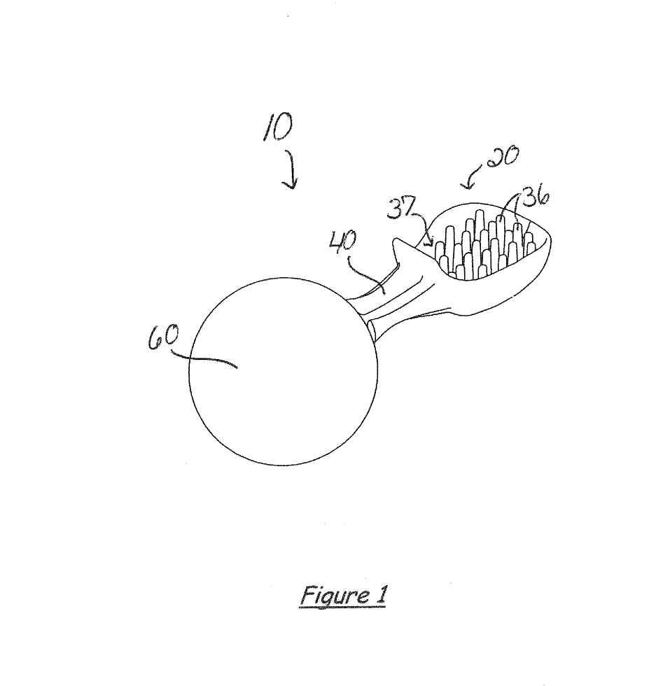

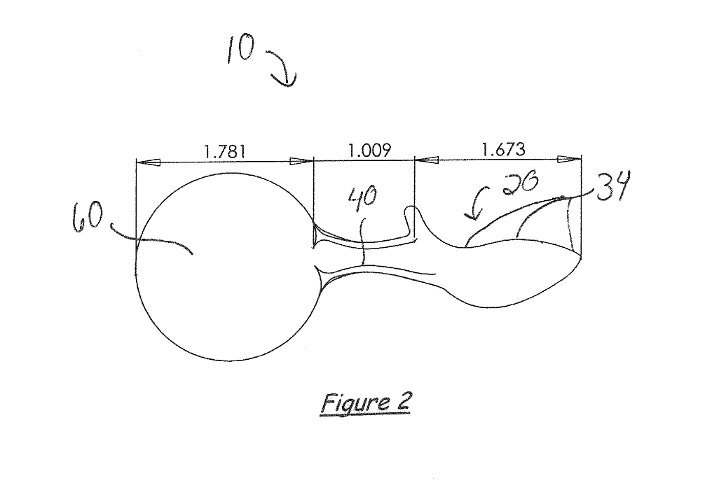

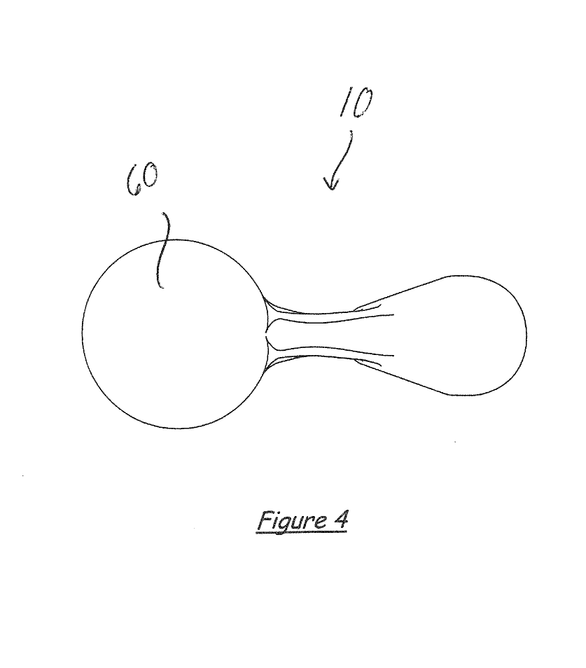

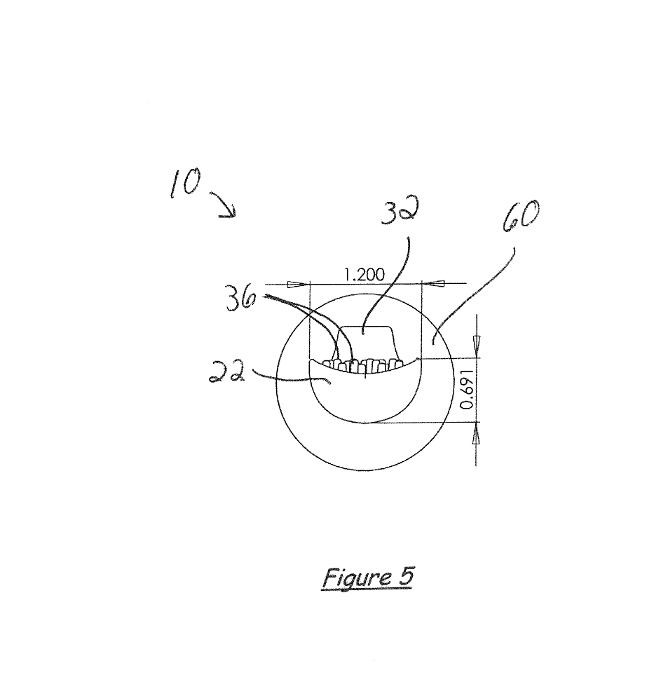

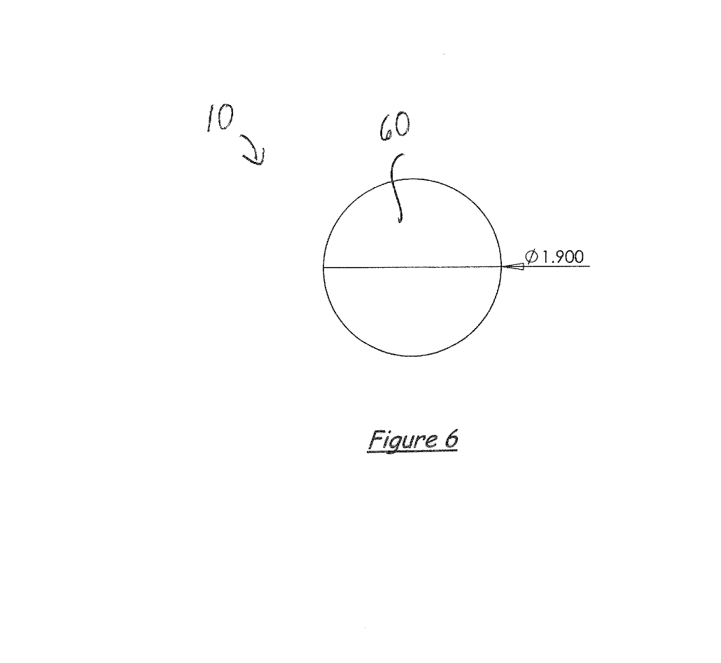

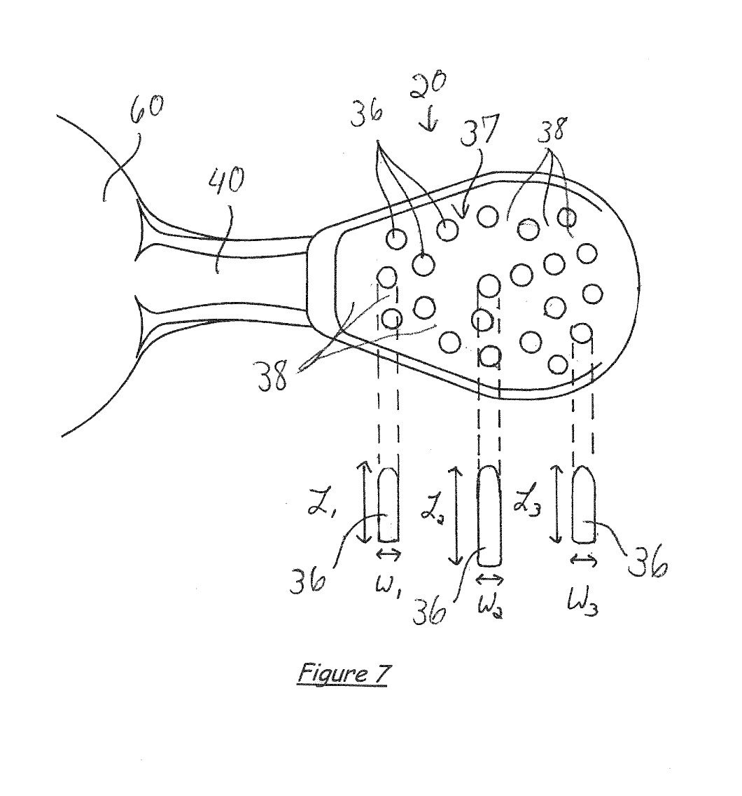

Referring specifically to the Figures, certain embodiments are shown, but there are other options, alternatives, and modifications that may be within the scope of the invention. Device 10 is one embodiment of an infant/toddler's utensil. FIGS. 1-6, 8A and B, and 9A and B are drawn close-to-actual size, that is, about 0.9-0.95 of actual size, and some preferred dimensions in inches are shown in FIGS. 2, 3 and 5. The device 10 is drawn to scale in FIGS. 1-6, 8A and B and 9A and B, so that the relative sizes and relative dimensions of the portions may be understood and one may obtain, for example, ratios of length, width, thickness, and radii, of various parts of the device from these drawings. FIG. 7 has been enlarged. In certain embodiments, alternative relative sizes of the portions may be used and/or alternative actual sizes may be used; for example, an adult may want an overall-larger utensil or a spherical handle that is larger relative to the head.

Referring to FIG. 1, the device 10 (also “utensil” and/or “oral care device”) comprises a head 20, neck 40, and handle 60. These three main portions of the device 10 are preferably permanently fixed to each other and/or integral with each other, without any detachable pieces. In certain embodiments, the main body of the head may be described as a bowl 22, and the bowl, the neck, and the handle portions are preferably rigidly- or generally-rigidly-connected together, so that the bowl does not bend significantly relative to the neck and the bowl-neck combination does not bend significantly relative to the handle. The bowl of the head, the neck, and the handle are preferably made of, or coated with, polymeric material that cushions contact with the user. The protrusions 36, which may be considered part of the head 20, are preferably permanently fixed to the bowl 22, but are preferably flexible or somewhat-flexible and so the bases/bottom ends may be described as being “rigidly” or “generally-rigidly” connected to the bowl of the head, but the protrusions in general will be flexible/somewhat-flexible.

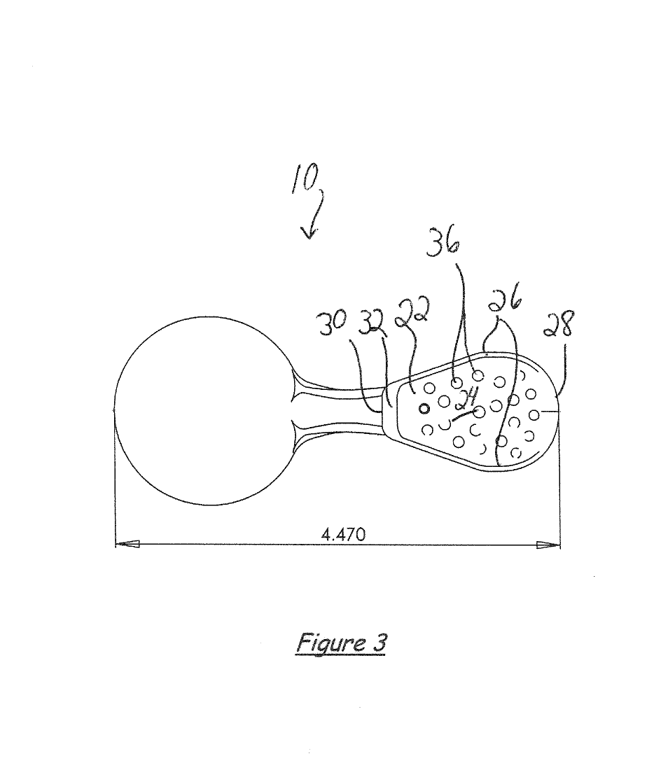

The concave bowl 22 of head 20 has bottom wall 24, side walls 26, front wall 28, and rear wall 30 with an upper extension 32 that acts as a food and mouth stop or control surface. See FIG. 3. The upper edge of the side walls and front wall define the upper rim 34. See FIG. 2. The bowl 22 is concave when viewed from above, and convex when viewed from below. The concave upper surface captures food and the convex lower surface allows some rocking or sliding of the head on a plate or food-bowl and is comfortable and ergonomic for insertion into, and removal from, the mouth.

The bowl-shaped head may be described, in certain embodiments, as pear-shaped in top view, with the rear being narrow relative to the blunt/flat front. The relatively flat front end will scoop food effectively when moved along a plate or bowl, and the narrow rear of the head connects with a narrow neck to provide ample room at the neck for finger or thumb placement around the handle.

The upper extension 32 typically reaches significantly higher than the side and front walls, and hence may be said to extend above the upper rim 34. Therefore, the extension may serve as a mouth-stop or “guard” to limit how far the device can be inserted into the mouth. It may also serve as a curved food-control surface, which limits how far back food moves when the user is scooping food off a plate/bowl, and against which the upper lip/teeth can slide or push to help with removing food from the head.

The bowl 22 may have flexible (flexible or somewhat flexible) and resilient portions, for example, the left and right sidewalls of the bowl-shaped head and the protrusions may be flexible (flexible or somewhat flexible) and resilient, with the bottom and rear walls being rigid, generally rigid, or having rigid or generally rigid portions. This way, the head can be used to scoop food generally in the direction of the longitudinal axis of the head, but, once the head is inserted into the mouth, compression of the mouth against the device head will tend to flatten/collapse the sidewalls and the protrusions, or at least some portions thereof. This will help free the food into the user's mouth, especially as the user slides/sucks the food off of the device head. It may be noted that it is desirable to have the protrusions sufficiently flexible to bend over then the user is scraping or sucking the food off the head of the device; even with this flexibility and even in the collapsed (flexed/bent) condition, the head of the device and the protrusions may provide sufficient surface for massaging or cleaning the teeth or gums.

The bowl 22, in certain embodiments, is more concave than a conventional spoon. For example, the head in FIGS. 1-9B curves on a radius along its longitudinal centerline in the range of about 0.75-0.9 inches (a diameter of about 1.5-1.8 inches and more preferably about 1.6-1.7 inches). The bowl is preferably also concave/curved in the transverse direction on roughly the same radius as the longitudinal concavity/curvature radius. The sidewalls may be described as upending form the concave/curved surface at the right and left side edges of said concave/curved surface. The bowl 2 is drawn in FIGS. 1-9B to be slightly longer than it is wide at its widest/maximum; the bowl length is preferably about 1.2-1.6 times the maximum width.

The multiple upending protrusions 36 are provided inside the interior space 37 of the in a number in the range of 5-40, more preferably for the preferred embodiment 10-30, or most preferably 15-25. The protrusions 36 are preferably parallel, spaced-apart, and broad relative to a conventional brush bristle. The protrusions 36 are preferably cylindrical or generally cylindrical, but may be other shapes, for example, square, rectangular, or oval in transverse cross-section. In certain embodiments, the protrusions may be elongated in a transverse direction, for example, an upending wall or ridge, but this is not preferred. A generally circular, square, or slightly oval transverse cross-section shape is preferred because food will more easily enter the spaces beside/between such protrusions and also more easily be removed from those spaces by the mouth, compared to spaces bounded/blocked by walls or ridges.

Each protrusion has a high thickness/diameter to length ratio compared to a conventional bristle, and a low thickness/diameter to length ratio compared to a nub or bump such as those provided on NUK/Gerber™ infant toothbrushes. For example, as illustrated in FIG. 7, protrusions 36 have a thickness/diameter W to length L ratio of about 1 to 3-6, and more preferably about 1 to 4-5. So, a protrusion in FIG. 7 having a 1 unit width/diameter has about a 4-5 unit length, for example, the range depending on where they are in the bowl space 37. Because the protrusions 36 preferably upend to the same or about the same level inside the bowl interior space 37, the protrusions 36 are of different lengths depending on whether they are in the middle (deepest portion) of the space 37, or around the outer edge (shallower portion) of the space. In certain embodiments, the protrusions upend to, or near to, the level of the upper rim. For example, protrusions may end at the same level, or as much as about 10 percent lower or higher than the upper rim.

The protrusions 36 are few, and a different thickness/diameter to length ratio, compared to conventional bristles in a toothbrush, which has hundreds of bristles of about 1 to 20, about 1 to 30, about 1 to 40, or about 1 to 50 W/L ratios, for example. The protrusions 36 also have a different thickness/diameter to length ratio compared to nubs/bumps such as are provided on a NUK/Gerber™ infant toothbrush, which have about a 1 to 2 or about a 1 to 1 W/L ratio.

The protrusions 36 are widely spaced-apart, so that there is significant open space 38 between the protrusions 36. For example, about 40-90 percent, more preferably about 50-80 percent, and most preferably about 60-80 percent, of the food-capture space 37 is open/empty in certain embodiments. In certain embodiments, each protrusion is spaced from each adjacent protrusion a distance equal to about 1-4 diameters of the protrusions, or more preferably about 1-3 diameters. In certain embodiments, such as the pear-shaped head 20 (top-view) of device 10, the thickness/diameter of the preferably generally cylindrical protrusions 36 is greater than or equal to 1/20 of the width of the bowl (at its greatest width) or more preferably about 1/10- 1/20 of the width of the bowl (at its greatest width). For example, in certain embodiments, for a head that is about 1.2 inches wide at its greatest width, the protrusions each may be about 0.12 inches in diameter or larger, and will be spaced about 0.12 inches apart (or more) in all directions. The protrusions may be spaced generally evenly around the interior space, and may be in a pattern (rows or columns, for example) or randomly located.

As discussed earlier in this document, the protrusions are adapted in number and size/shape to provide substantial room for food capture between the protrusions, including for bits of solid food. Therefore, one may understand from this disclosure that the food-capture space 37 may be defined as the three-dimensional space bounded by the concave/curved upper surface of the main body of the head, the inner surfaces of the sidewalls/edges of the concave/curved main body, and the top ends of the protrusions. To the extent that the protrusions reside in that three-dimensional space, some of said space is full (or protrusions) and some is open/empty (space between and around the protrusions), as described above in this paragraph. It may also be understood that food may be captured in this food-capture space and/or may hang or protrude slightly outside of said space depending on its texture and the content and size/shape of the solids therein. For example, given chunky soups or stews, the liquid component will tend to fill the concave/curved main body of the head, and the food chunks may rest in/on the head but protrude up above the upper rim and the protrusions top ends.

The handle 60 of device 10 is preferably a sphere or substantially a sphere. The preferred handle is not elongated or significantly oval. In certain embodiments, the handle 60 may be exactly a sphere (except perhaps in the area of the slight modification allowing attachment to the neck of the device), for example, with the diameters extending through the center of the sphere varying less than 2 percent in certain embodiments. In certain embodiments, the handle may be “substantially” a sphere because the diameter is not exactly the same all around the handle, for example, with diameters extending through the center of the sphere as varying by 2-10 percent. In certain embodiments, the spherical surface may include dimples, bumps, ridges, or other texture and still be “generally spherical”. Even in embodiments that are “substantially spherical”, an observer would consider the handle a sphere or a spherical “ball”, and would be able to grasp it as such.

The handle for an infant or toddler is preferably in the range of about 1.6-2.0 inches in diameter, and more preferably about 1.78 inches in diameter as indicated on the drawings. For an adult, the handle might be larger, for example, in the range of about 2-4 inches in diameter. The handle, and the entire device, may be manufactured in multiple sizes, for example, infant-size, toddler size, and small, medium and large teen/adult size.

The neck 40 serves as a connective transition between the handle 20 and the head 60, and is narrow enough to allow the user to curl his/her fingers around the handle with little or no interference by the neck. In certain embodiments, reinforcement or other strengthening techniques may be done in the molding process to ensure that the narrow neck does not bend a significant amount during use.

The device may be made of various materials, for example, one or more polymer materials or other materials that are suitable for use in the mouth and by children. The materials, for example, inner reinforcement materials with outer coatings/covers, preferably have the desired properties in terms of firmness, rigidity, semi-rigidity, and/or flexibility described herein, are food-safe, and preferably are cleanable or sterilizable in a dishwasher or other cleaning device.

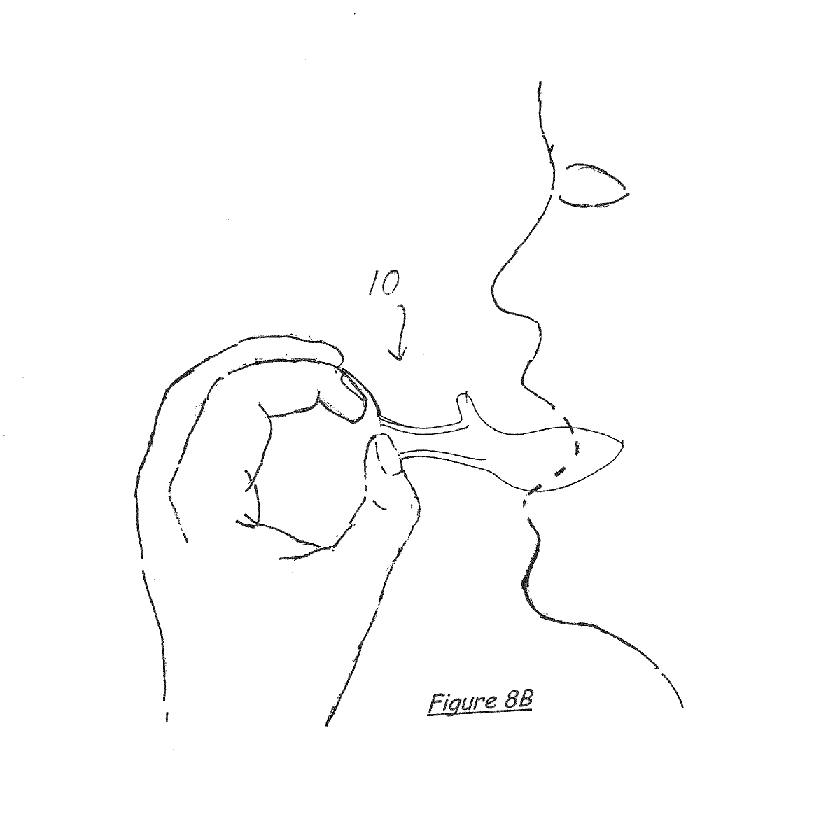

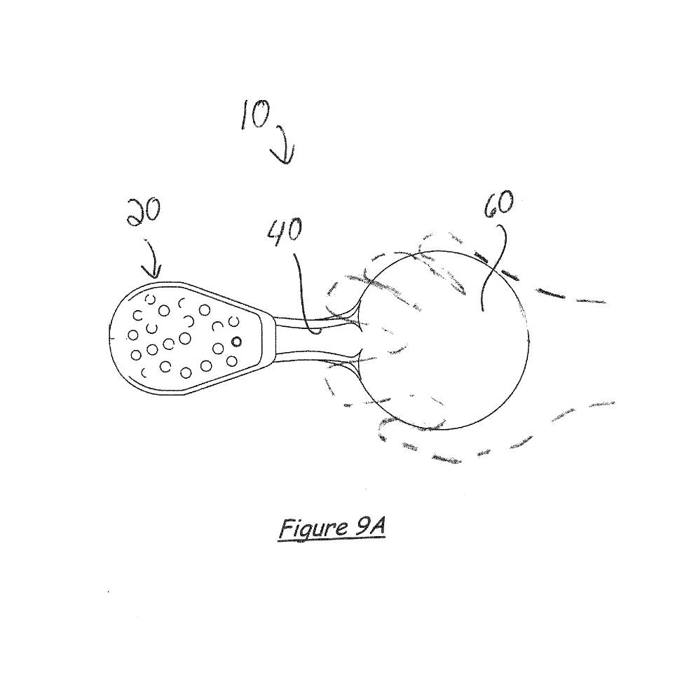

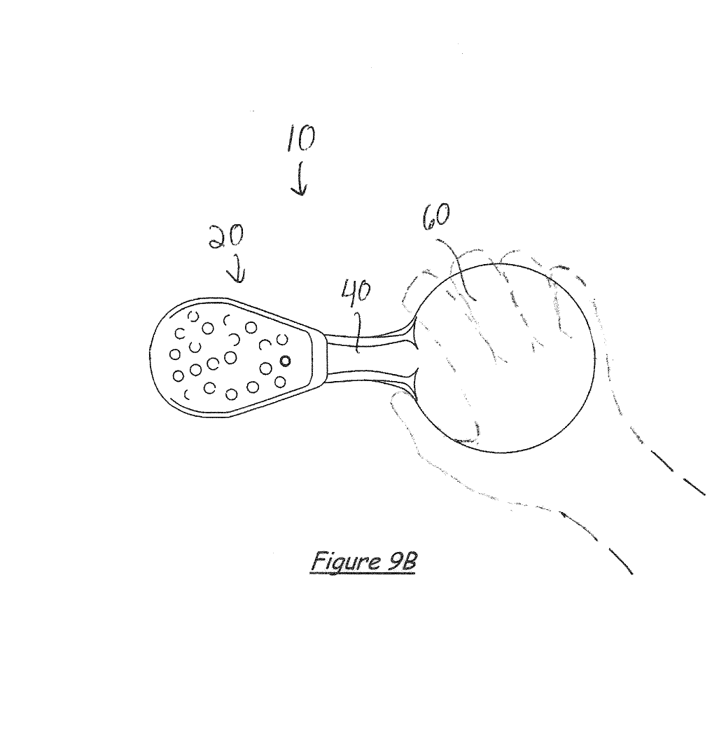

In use, the device 10 is unusual and beneficial compared to conventional utensils. As discussed above in this document, the grasping position and the hand and arm movements used in eating with this utensil are more natural and versatile than with conventional utensils. For example, as suggested by FIGS. 8A and 8B, a user may grasp the handle 60 of the device 10 as he/she would grasp a ball, and curl his/her arm upward toward the mouth with the palm generally facing the user's mouth. As shown by the difference between FIGS. 8A and B, because of the spherical shape of the handle and the narrow neck, there is a lot of leeway in how the user grasps the handle and how the user can move the head of the utensil to the mouth. For example, in FIG. 8B, the user's palm is much lower on the handle than in FIG. 8A, that is, rotated about 45 degrees compared to its position in FIG. 8A relative to the longitudinal axis of the utensil device. Other variations in the grasping position are illustrated in FIGS. 9A and B. For example, in FIG. 9A, the palm may be generally centered at the rear of the handle (opposite the head), with the thumb and first finger on one side of the neck and the other fingers on the opposite side of the neck. In FIG. 9B, the hand is shifted/rotated relative to the longitudinal axis of the utensil device, to a position wherein the thumb is on one side of the neck and the fingers are all on the opposite side of the neck.

### Especially-Preferred Embodiment

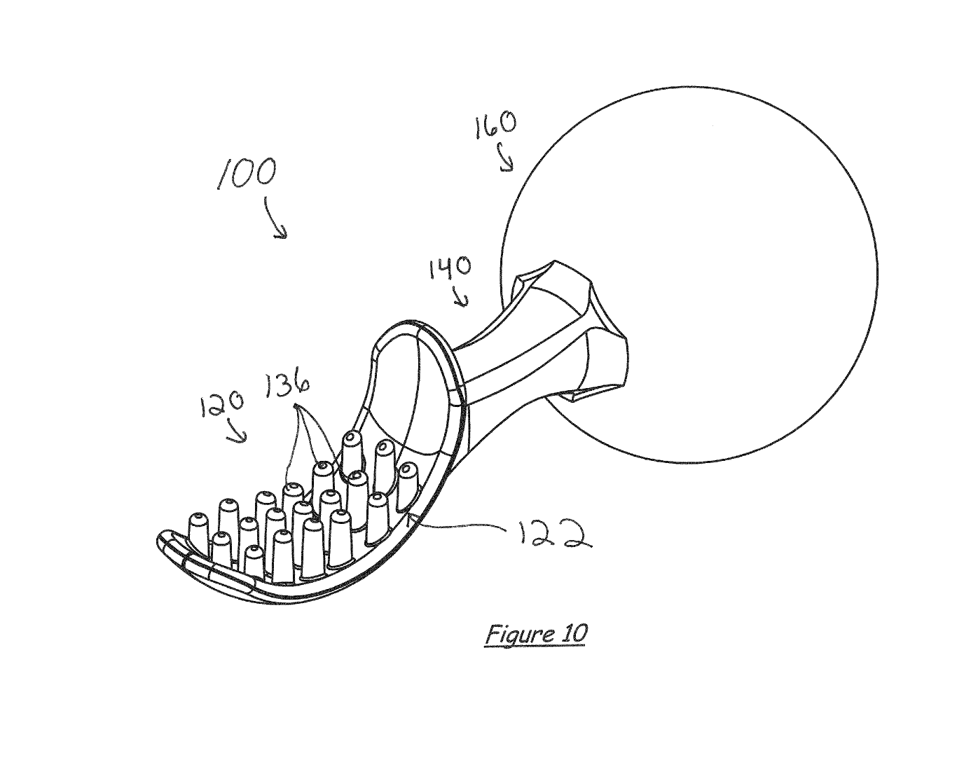

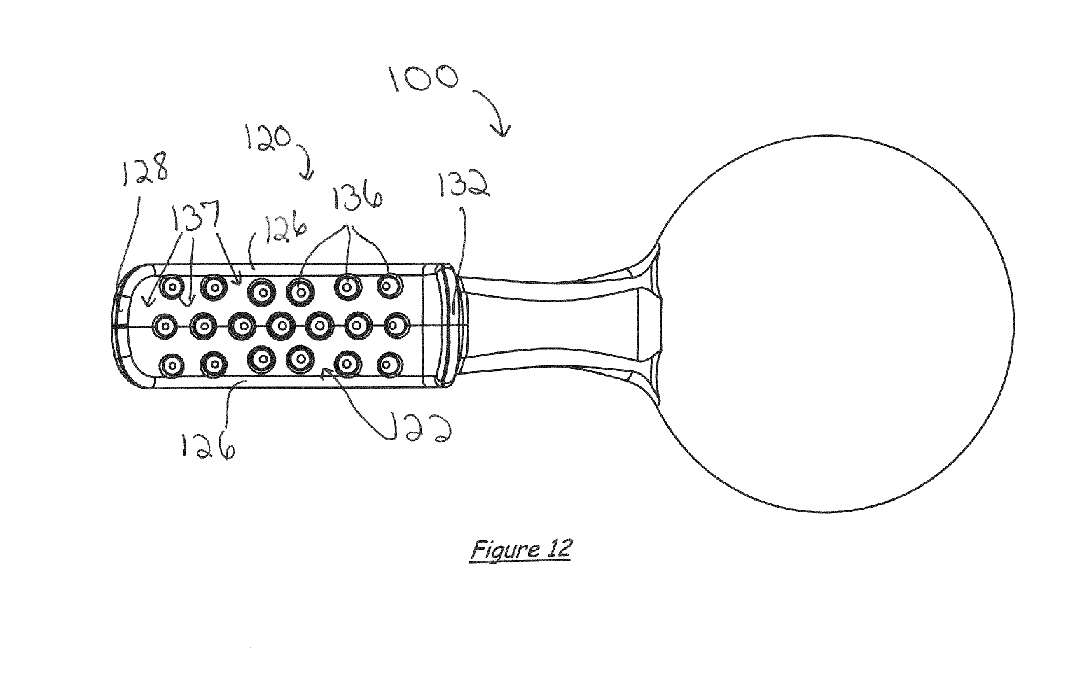

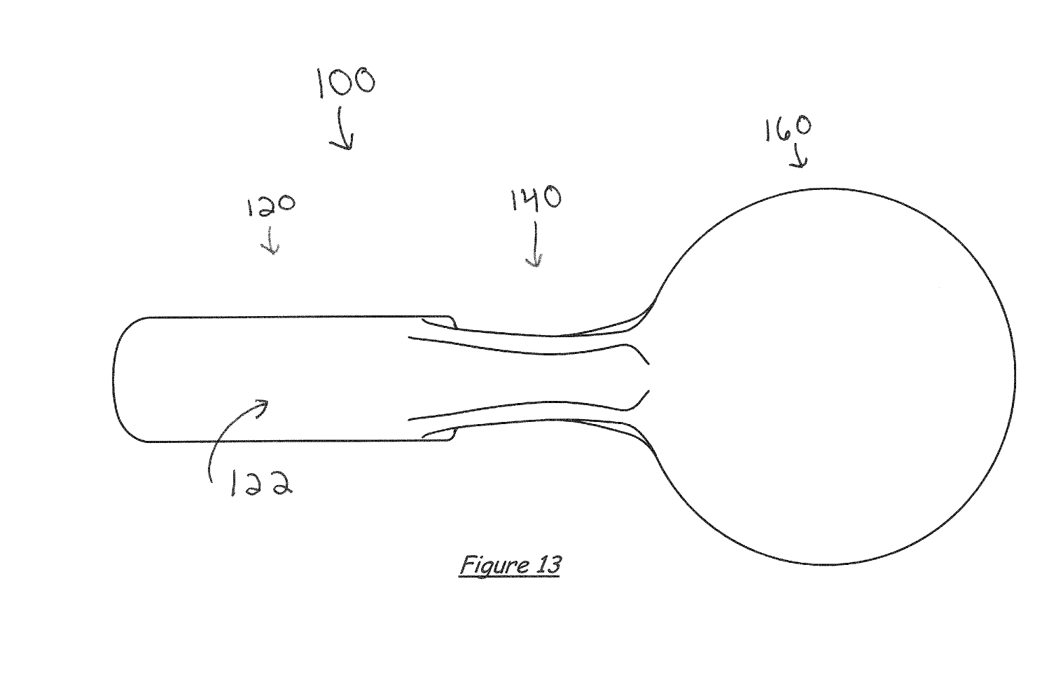

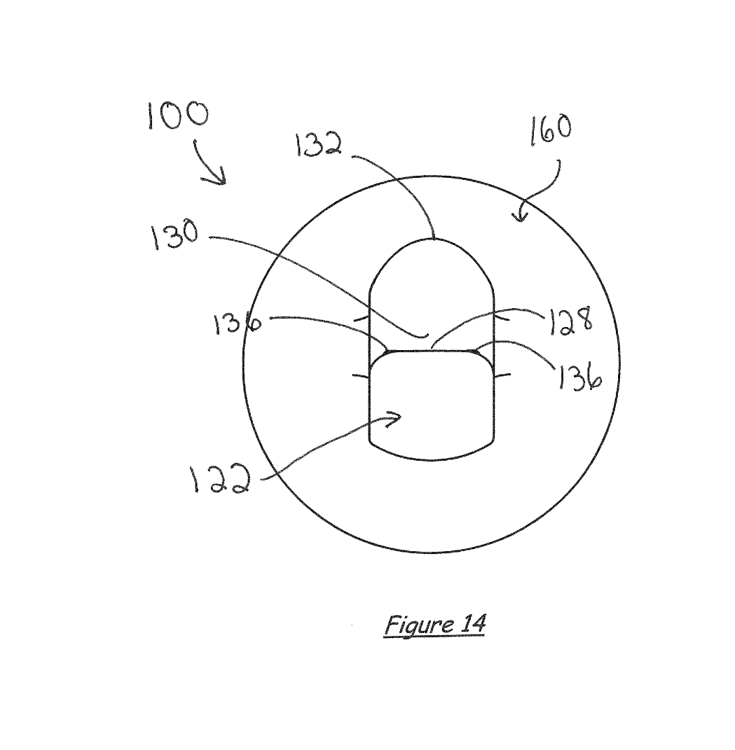

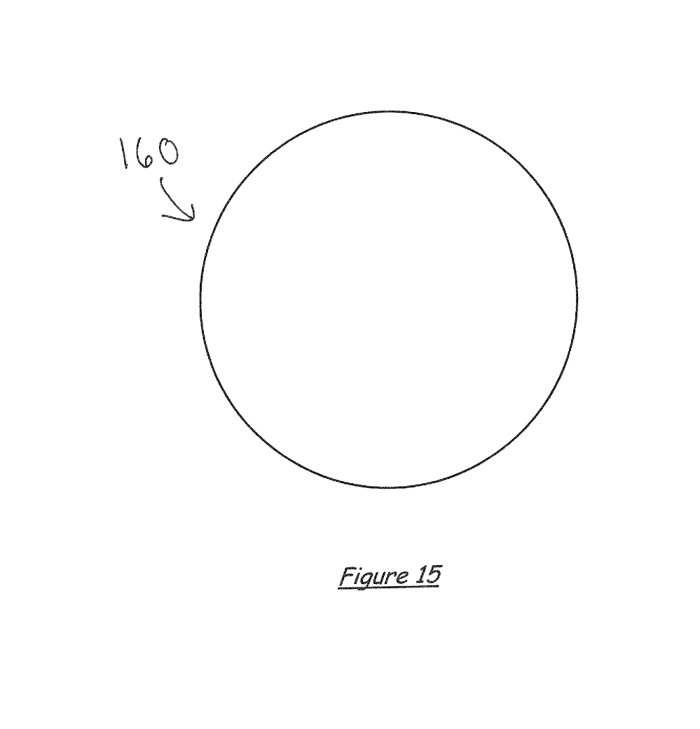

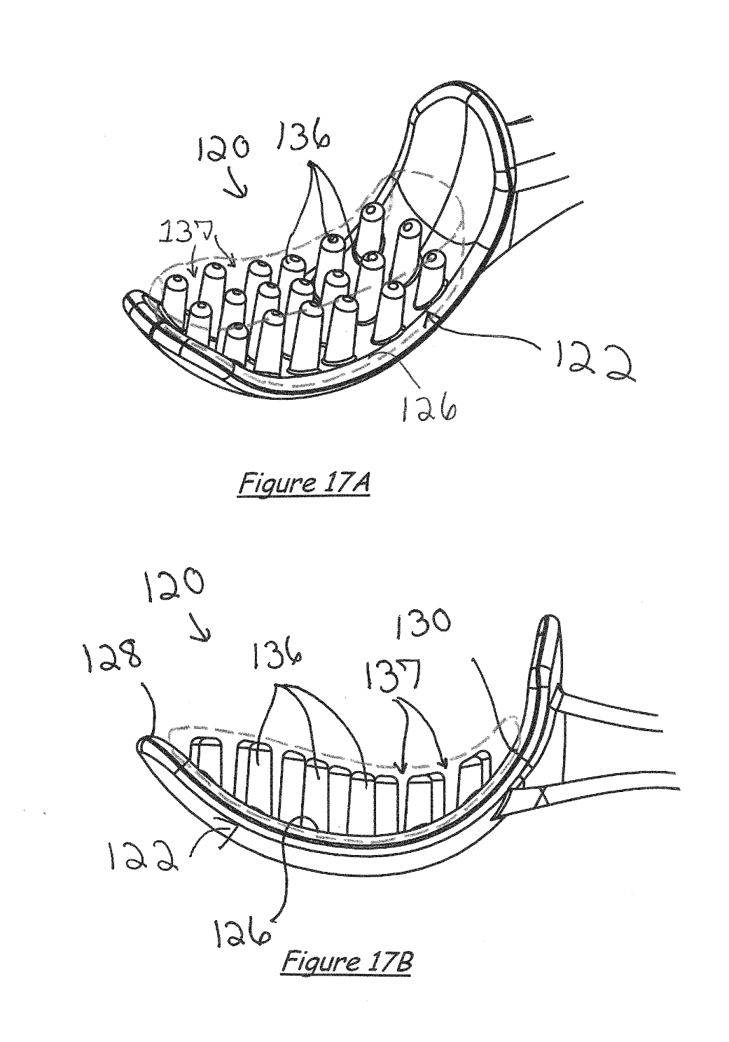

FIGS. 10-17B portray an alternative embodiment of the utensil and/or oral care device 100. FIGS. 10-16E are drawn to scale and approximately 2:1 (larger than the utensil will typically be made. FIGS. 17A and B have been enlarged. Device 100 features much of the same structure, features, material, and uses as described above for device 10, with the main differences centering around the shape and structure of the head 120. Head 120 comprises a curved main body, which may be described as a curved arm 122. The curvature of the arm 122 is similar to the curvature of the bottom wall 24 of head 20 of device 10, from front to back, but arm 122 is not as wide as, and does not feature side walls as tall as those (side walls 26) of, device 10. Arm 122 may be described as curved/concave from front to back, curved/concave from side-to-side, and generally open at its sides.

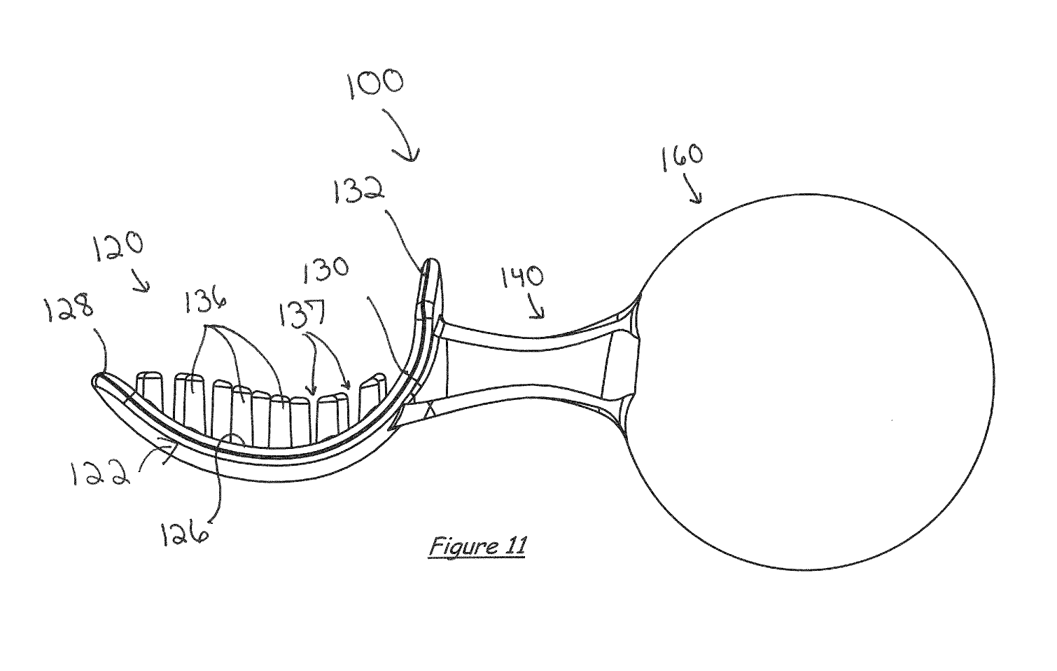

Protrusions 136 upend from the concave inner surface (upper surface) of the arm 122, to heights that result in the top ends of the protrusions being generally at the same level as the front wall/end 128 of the arm 122, but above the short side walls 126 of head 120. As best seen in FIGS. 10 and 11, the top ends of the protrusions as not all at the same level, but rather the front-most protrusions and the rear-most protrusions are about the same height and about at the same level as front wall/end 128. The top ends of the other protrusions become slightly progressively lower from the front to the rear, defining a slight “wave” in the height of the protrusions when viewed from the side. In addition, because the protrusions upend from a curved surface, their lengths vary based on what portion of the curved surface they upend from.

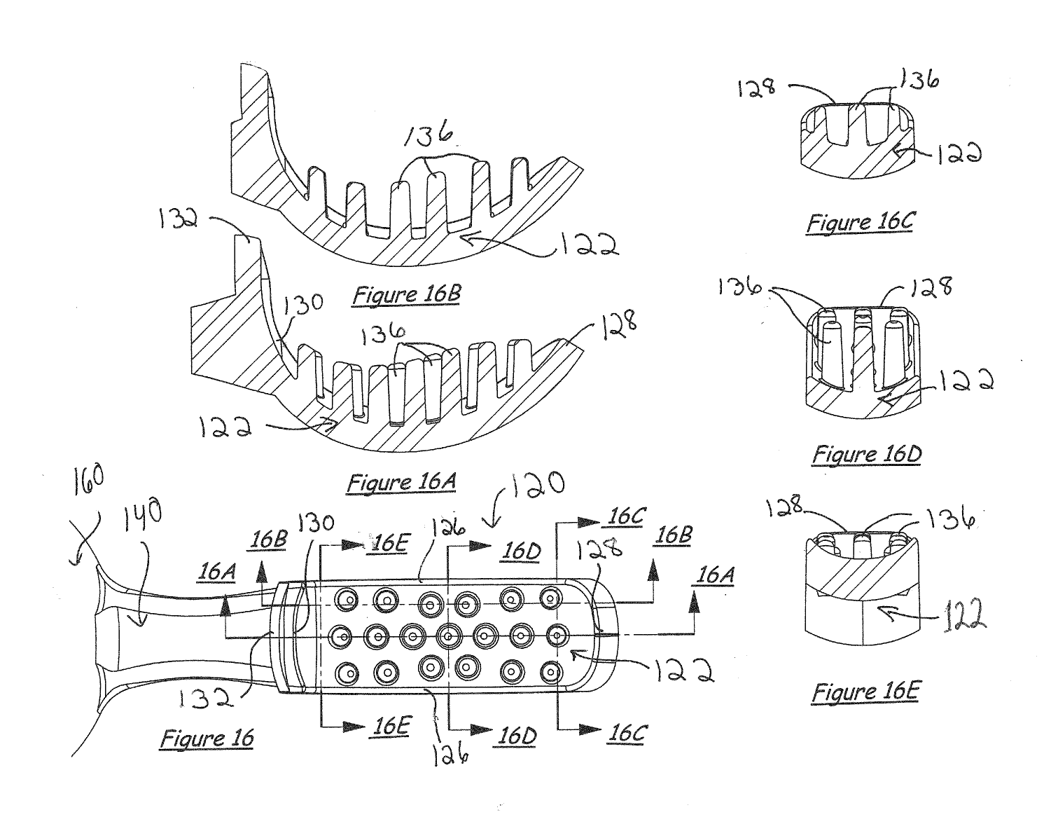

The arm 122 may be seen to be significantly narrower than is the main body of the head 22 of device 10. Arm 122 may be, for example, about 0.5-0.7 inches wide and about 1.1-1.7 inches long so that it is over twice as long as it is wide. The arm 122 has a generally uniform width all along its length and so is not described as “pear-shaped”. Rather, the front wall/end 128, the rear wall 130, and the middle region in between, are all about the same width. Rather than being called a “bowl”, the arm 122 may be described as an elongated arm, which is curved/concave in its longitudinal direction, and slightly curved/concave in its transverse direction. Thus, the arm 122 also may be described as being rounded from side-to-side on its bottom surface, and convex from side-to-side on its top surface (in top view). The top and bottom surfaces of the arm 122 each curve along the arm longitudinal centerline on a radius, for example, in the range of about 0.75-0.9 inches (a diameter of about 1.5-1.8 inches and more preferably about 1.6-1.7 inches). The top and bottom surfaces of the arm 122 also each curve transversely (side-to-side), for example, on a radius of about 50-80%, and more preferably about 60-70%, of the radius of longitudinal curvature (compare FIGS. 16A and 16D, for example). Therefore, an exemplary side-to-side curvature for embodiments wherein the longitudinal curvature has a radius of about 0.8 inches is about 0.4-0.64 inches, or more preferably about 0.48-0.56 inches.

Although the arm 122 is transversely curved/concave, it is fairly narrow, with the result that the outer side edges are only slightly higher than the longitudinal centerline of the top surface of the arm 122. These slightly higher side edges may be called the sidewalls 126 of device 100 or the arm 122 may additionally comprise sidewalls upending from right and left edges of the concave/curved surface. Such sidewalls may be short, for example, a height of ⅙- 1/20 of the length of the head. Having low side walls and/or no side walls may create a three-dimensional food-capture space 137 in/on the head that is more open at the sides than in the case of the food-capture space 37 of device 10, and, in certain embodiments, this will have benefits. Some benefits of certain low/no side wall embodiments may include, for example, easier food-capture when the user tries to scoop, push or slide food onto the head, and/or easier food-release when the user places the head in his/her mouth and sucks or pulls the food off the head. See FIGS. 17A and B, which schematically portray, in dashed lines, the outer boundaries of the food-capture space 137 of head 120. The space 137 will be understood to be bounded generally by the top surface of the arm 122, the outer surfaces of the outermost protrusions 136 and/or the side walls 126, and the top ends of the protrusions 136. As the top surface is somewhat concave, the dashed lines showing the lower outside edge of the space 137 is shown slightly below the top edge of the side walls 126.

As may be seen to best advantage in FIG. 11, the rear wall 130 extends upward higher than the front wall/end 128 to form an upper extension 132 that acts as a food and mouth stop or control surface, in a similar or the same manner as describe above for upper extension 32. After insertion of the head 120 of this device 100 into the user's mouth, the user may pull the head out of the mouth with the top lip and/or teeth sliding along the front surface of the upper extension 132, across the protrusions 126 (which may bend/flex in response), and then across the front well/end 128. This process will allow removal of food form the three-dimensional food-capture space 137, including by pushing/sucking the food off the left and right side of the heads. The low side walls 126 of the embodiments of FIGS. 10-16E, therefore, provide some food containment and control function during dipping/scooping of the device 100 into food, for better capture of the food, but also allow said pushing of the food off the right and left side, and/or optionally tipping the utensil so that liquid and/or food bits fall off of the head into the mouth, for quicker and more satisfying food removal. Preferably the arm 122 is not significantly flexible, so that is does bend/straighten in the user's mouth, but the arm 122 is of a moderate curvature so that most of the food may be sucked-pushed off the head 120 by most users.

As may be seen in the drawings, the neck 140 and handle 160 of device 100 are similar or the same as those described for device 10, for example, similar or the same in their shapes, relationships to each other, relative sizes, connection or integral-formation, materials, and purposes. The handle 160 of device 100 may be grasped and manipulated as described and portrayed in FIGS. 8A and B and 9A and B, for example.

In this alternative embodiment, utensil and/or oral care device 100, the head 120 is more narrow and there are fewer protrusions spaced along the width of the head 120, compared to head 20. In such narrow heads 120, the number of protrusions spaced across the width of the head may be a few, for example, 3-4, or more preferably three as shown in the drawings. The number of protrusions spaced across the length of the head may be several, for example, 4-10, or more preferably 5-8, or most preferably six as shown in the drawings. The thickness/diameter of the preferably generally cylindrical protrusions 136 in device 100 is greater than or equal to 1/10 of the width of the bowl or more preferably about ⅕- 1/10, and most preferably about ⅕- 1/7 of the width of the bowl. For example, in certain embodiments, for a head that is about 0.6 inches wide (at its greatest width, or in the case of head 120 all along the length of the head), the protrusions each may be about 0.12 inches in diameter or larger, and will be spaced about 0.6-0.24 inches apart (or more) in all directions. The protrusions may be in a pattern such as rows and columns in device 100, or randomly located, for example.

The protrusions 136 are relatively few, and a different thickness/diameter to length ratio, compared to conventional bristles in a toothbrush, which has hundreds of bristles of about 1 to 20, about 1 to 30, about 1 to 40, or about 1 to 50 W/L ratios, for example. The protrusions 136 also have a different thickness/diameter to length ratio compared to nubs/bumps such as are provided on a NUK/Gerber™ infant toothbrush, which have about a 1 to 2 or about a 1 to 1 W/L ratio. For example, each protrusion 136 has a high thickness/diameter to length ratio compared to a conventional bristle, and a low thickness/diameter to length ratio compared to a nub or bump such as those provided on NUK/Gerber™ infant toothbrushes. For example, protrusions 136 have a thickness/diameter W to length L ratio of about 1 to 3-6, or more preferably about 1 to 3-4. So, a protrusion in FIG. 11 having a 1 unit width/diameter has about a 3-6 unit length or more preferably about a 3-4 unit length, for example, the range depending on where they are in the food-capture space 137. Because the protrusions 136 preferably upend to the same or about the same level inside the bowl interior space 137, the protrusions 136 are of different lengths depending on whether they are in the front-middle (deepest portion) of the space 137, or in the front-most or rear-most portions (shallower portions) of the space.

The protrusions 136 are spaced-apart, so that there is significant open space 138 between the protrusions 36, for example, so that about 40-90 percent, more preferably 50-80 percent, and most preferably about 60-80 percent, of the space 137 is open/empty in certain embodiments. In certain embodiments, each protrusion is spaced from each adjacent protrusion a distance equal to about 0.5-4 diameters of the protrusions, or more preferably about 0.5-2 diameters. This spacing, while somewhat closer than that shown for device 10, provides substantial open/empty room for food capture between the protrusions, including for bits of solid food. The spacing may be adapted for different foods and/or older users who may be eating larger bits of solid food.

Although this disclosed technology has been described above with reference to particular means, materials and embodiments, it is to be understood that the invented technology is not limited to these disclosed particulars, but extends instead to all equivalents within the broad scope of the following claims.

1. An eating or oral care utensil comprising:
a head having a concave upper surface defining an interior space;
a plurality of protrusions upending from the upper surface into the interior space, each protrusion having a protrusion diameter and a protrusion length; and
a handle connected to the head for being grasped by a user;
wherein the protrusions have a diameter to length ratio of about 1 to 3-6.

2. A utensil as in claim 1, wherein the protrusions are flexible.

3. A utensil as in claim 1, wherein the head is elongated and has a curved bottom wall that has a top surface that is said concave upper surface, the head further having a front wall at a front end of the bottom wall, a rear wall at a rear end of the bottom wall, and a longitudinal axis between the front wall and the rear wall, and a width transverse to the longitudinal axis.

4. A utensil as in claim 3, wherein the head further has side walls that upend from the concave upper surface a distance equal to ⅙- 1/20 of the length of the head.

5. A utensil as in claim 1, wherein the head is elongated, and has a width and a length, the length being over 2 times the width.

6. A utensil as in claim 1, wherein the head is bowl-shaped and has a maximum width and a maximum length, the maximum length being about 1.2-1.6 times the maximum width.

7. A utensil as in claim 1, wherein the handle is spherical.

8. A utensil as in claim 3, wherein the handle is spherical.

9. A utensil as in claim 1, wherein protrusions are provided in a number inside the interior space of the head that leaves 40-90 percent of the interior space empty for receiving food.

10. A utensil as in claim 10 comprising only 15-25 protrusions.

11. A utensil as in claim 3 wherein the concave upper surface is curved along its longitudinal axis on a radius of about 0.75-0.9 inches, and the concave upper surface is curved along its width on a radius of about 0.4-0.64 inches.

12. An eating utensil comprising:
a head having a concave upper surface defining an interior space;
a plurality of protrusions upending from the upper surface into the interior space; and
a generally spherical handle connected to the head for being grasped by a user.

13. A utensil as in claim 12, wherein the protrusions are flexible.

14. A utensil as in claim 12, wherein the head is elongated and has a curved bottom wall that has a top surface that is said concave upper surface, the head further having a front wall at a front end of the bottom wall, a rear wall at a rear end of the bottom wall, and a longitudinal axis between the front wall and the rear wall, and a width transverse to the longitudinal axis.

15. A utensil as in claim 14, wherein the head further has side walls that upend from the concave upper surface a distance equal to ⅙- 1/20 of the length of the head.

16. A utensil as in claim 12, wherein the head is elongated, and has a maximum width and a maximum length, the maximum length being over 2 times the maximum width.

17. A utensil as in claim 12, wherein protrusions are provided in a number inside the interior space of the head that leaves 40-90 percent of the interior space empty for receiving food.

18. A utensil as in claim 14 comprising only 15-25 protrusions.

19. A utensil as in claim 12 wherein the concave upper surface is curved along its longitudinal axis on a radius of about 0.75-0.9 inches and the concave upper surface is curved along its width on a radius of about 0.4-0.64 inches.

20. A utensil as in claim 12 wherein the head is bowl-shaped and has a maximum width and a maximum length, the maximum length being about 1-1.6 times the maximum width.
